(19) United States
(12) Patent Application Publication
(10) Pub. No.: US 2012/0072087 A1
(43) Pub. Date: Mar. 22, 2012

(54) SYSTEMS AND DEVICES FOR CONVEYING A MOVING STATUS OF A MOTORIZED VEHICLE

(76) Inventors: MICHAEL CHUNGFANG WU, walnut, CA (US); Esther Huang Wu, Walnut, CA (US); Joanne Nai-June Wu, Walnut, CA (US)

(21) Appl. No.: 12/883,477

(22) Filed: Sep. 16, 2010

(51) Int. Cl. B60Q 1/26; B60Q 1/00

(52) U.S. Cl. 701/70; 340/441

(57) ABSTRACT

The present invention provides a system for conveying a moving status of a motorized vehicle. The system includes a decelerating device operable to slow down the motorized vehicle; a measuring device electrically coupled to the decelerating device to measure an instantaneous speed of said motorized vehicle at a time the decelerating device is activated; and a displaying device electrically coupled to the measuring device to display the instantaneous speed to an object behind the motorized vehicle.

### FIELD OF THE INVENTION

The present invention relates to systems and devices for conveying a moving status of a motorized vehicle; specifically, the present invention relates to systems and devices for conveying a moving status of a motorized vehicle to an object therebehind so as to provide safety information.

### BACKGROUND OF THE INVENTION

Traffic accidents are often caused because of an abrupt stop by front moving vehicles. When traveling in high speed, car drivers may only have a split second to react to a slow down or a complete stop of the car in front. The current automobiles are equipped with two rear brake lights to signal a decrease in speed. Additionally, a third brake ligh, usually located on a rear windshield of the cars, to signal the same. Conventionally, when a foot brake is pressed by the driver of the front vehicle, the two rear brake lights in red color will be lit up to warn the driver behind the front vehicle of the slow down. Subsequently, the driver behind will press his/her foot brake to prevent a collision.

However, these conventional brake lights do not provide the driver behind the front vehicle with information other than that the driver in the front vehicle has pressed the foot brake and thus the speed is decreased. As a result, when traveling in high speed, the driver beind the front vehicle can only step on the foot pedal as hard as possible, or as often as he/she can, during that slip second to slow dow the car in response to the warning brake lights of the front vehicle without knowing whether the front vehicle will either reduce its speed or go to a complete stop.

Therefore, what is needed is a system for conveying a moving status of a motorized vehicle. Ideally, the system can convey an instantaneous speed of the motorized vehicle at the time a foot brake installed therein is pressed to display the speed the front vehicle is operating at to the driver behind. As a result, the driver behind the front vehicle can adjust his/her speed to keep a safety distance from the front vehicle accordingly.

### SUMMARY OF THE INVENTION

In light of the drawbacks of the above prior art, the present invention provides systems and devices for conveying a moving status of a motorized vehicle to an object behind the motorized vehicle so as to provide safety information.

In one aspect of the present invention, a system for conveying a moving status of a motorized vehicle is provided. The system in accordance with the present invention includes a decelerating device operable to slow down the motorized vehicle; a measuring device electrically coupled to the decelerating device to measure an instantaneous speed of said motorized vehicle at a time the decelerating device is activated; and a displaying device electrically coupled to the measuring device to display the instantaneous speed to an object behind the motorized vehicle.

In another aspect of the present invention, a device for conveying a moving status of a motorized vehicle is provided. The device in accordance with the present invention is adapted to work with the motorized vehicle. The device of the present invention includes a signal processor electrically coupled to a speed detector of said motorized vehicle to convert a speed signal detected by the speed detector into a numeric display; and a displaying element disposed at a rear end of the motorized vehicle to display the numeric display to an object behind the motorized vehicle.

In yet another aspect of the present invention, a system for showing a moving status of a motorized vehicle is provided. The system in accordance with the present invention includes a measuring device measuring an instantaneous speed of the motorized vehicle; and a displaying device electrically coupled to the measuring device, wherein the displaying device is disposed in a rear end of the motorized vehicle so as to display the instantaneous speed measured by the measuring device to an object behind the motorized vehicle.

### BRIEF DESCRIPTION OF THE DRAWINGS

FIG. 1 is a block diagram of a system for conveying a moving status of a motorized vehicle in accordance with one embodiment of the present invention;

FIG. 2 is a block diagram of a device for conveying a moving status of a motorized vehicle in accordance with one embodiment of the present invention;

FIG. 3a is a schematic view illustrating a system for conveying a moving status of a motorized vehicle in accordance with one embodiment of the present invention; and

FIG. 3b is a schematic view illustrating a system for conveying a moving status of a motorized vehicle in accordance with another embodiment of the present invention.

### DETAILED DESCRIPTION OF THE DRAWINGS

The present invention will now be described through the following embodiments. However, it is understood by those skilled in the art that the embodiments described below are for illustration purpose only and are not intended to limit the scope of the present invention. Similar reference numbers refer to similar components in the accompanying drawings throughout the specification.

The present invention provides a system for conveying a moving status of a motorized vehicle. In one embodiment of the present invention, the motorized vehicle may be an automobile. However, any other motorized vehicles, such as a boat, a truck, and the like, are also within the scope of the present invention. In the embodiment where the motorized vehicle is an automobile, the system of the present invention may convey a moving status, such as a speed, of the automobile. However, the system of the present invention may also convey other moving status of the motorized vehicle, such as a distance or time necessary for the moving automobile to stop.

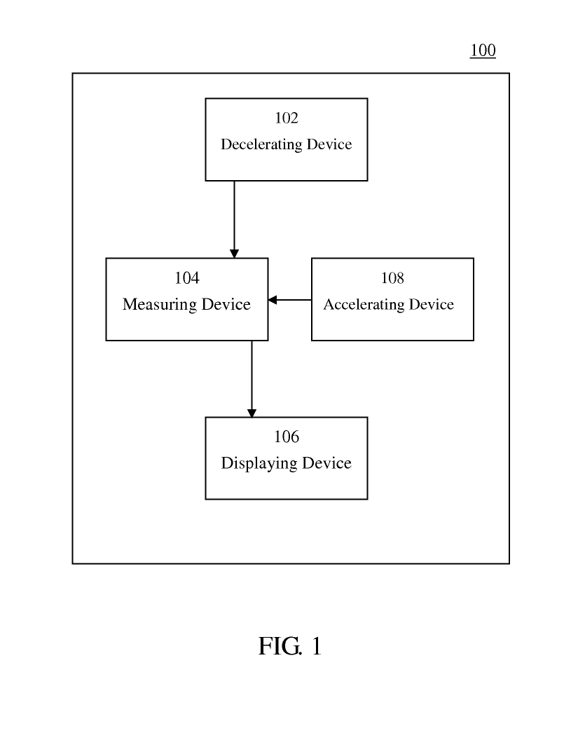

Refer now to FIG. 1, which illustrates a block diagram of the system for conveying a moving status of a motorized vehicle in accordance with one embodiment of the present invention. As shown in FIG. 1, in one embodiment of the present invention, the system for conveying a moving status of a motorized vehicle 100 may include a decelerating device 102. As an example, the decelerating device 102 may be a foot brake installed at the driver's side in an automobile. The decelerating device 102 of the present invention may be used to slow down the motorized vehicle. In the example where the motorized vehicle is an automobile, an operator of the automobile may activate the decelerating device 102 by applying pressure to the decelerating device 102, such as by stepping on the foot brake, so as to slow down the automobile when the traffic is congested.

In accordance with the present invention, the system of the present invention 100 may also include a measuring device 104. In one embodiment of the present invention, the measuring device 104 may be used to measure an instantaneous speed of the motorized vehicle. For example, the measuring device 104 may be a speedometer installed in a car. In accordance with the present invention, the measuring device 104 may be electrically coupled to the decelerating device 102 so as to measure the instantaneous speed of the motorized vehicle at the time the decelerating device 102 is activated. In one embodiment, the decelerating device 102 may be activated by an operator of an automobile stepping on the foot brake, as mentioned above. As such, when the car is decelerating, the measuring device 104, such as the speedometer, may show the reduced speed at which the car is operating.

In accordance with the present invention, the system 100 may also include an accelerating device 108. The accelerating device 108 of the present invention may accelerate the speed of the motorized vehicle. In accordance with the present invention, the accelerating device 108 may be electrically coupled to the measuring device 104 to allow the measuring device 104 to measure the instantaneous speed when the accelerating device 108 is activated. In one embodiment, the accelerating device 108 may be activated by an operator of an automobile stepping on a gas pedal installed therein. As such, when the car is accelerating, the measuring device 104, such as the speedometer, may show the increased speed at which the car is operating.

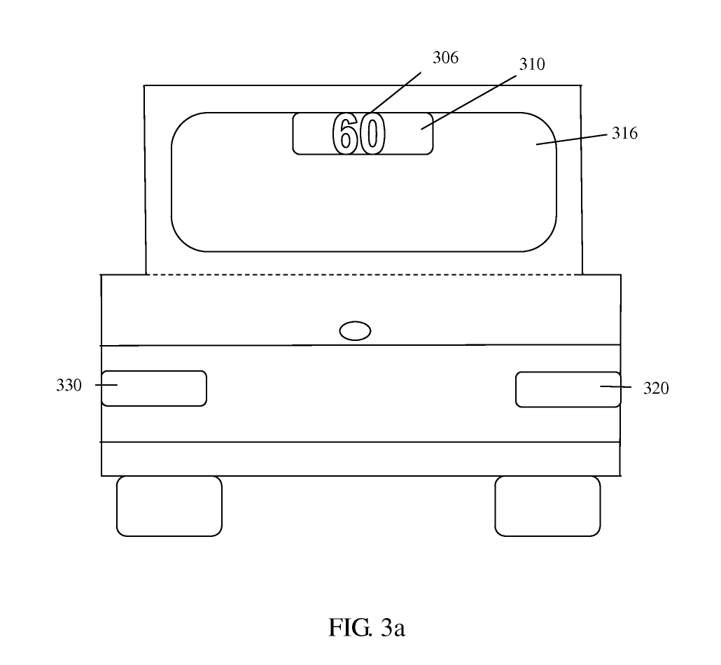

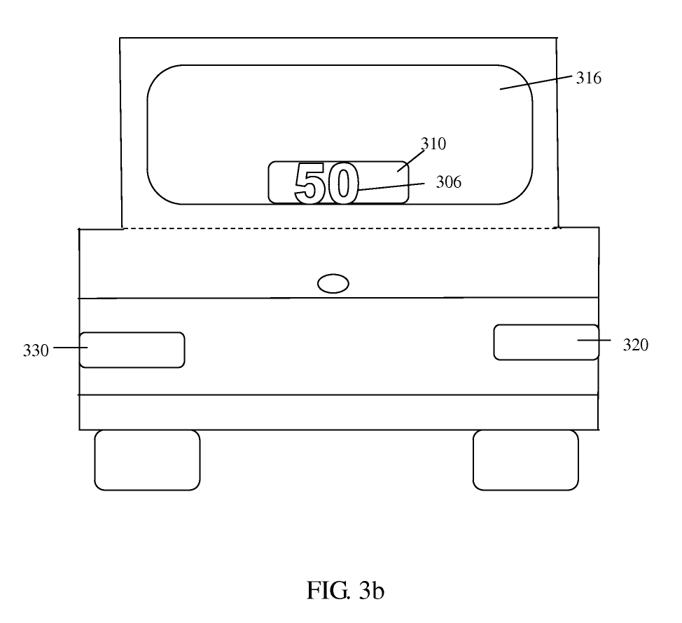

In accordance with the present invention, the system 100 may also include a displaying device 106. The displaying device 106 of the present invention may be electrically coupled to the measuring device 104 so as to display the instantaneous speed measured by the measuring device 104 to an object behind the motorized vehicle. For example, the automobile may be moving at a constant speed at 70 miles per hour before the decelerating device 102 is activated. At the time the decelerating device 102 is activated, such as when the operator of the automobile steps on the foot brake, the speed of the automobile may be reduced to 60 miles per hour, as shown in FIG. 3a. As such, the displaying device 106 may display such speed to the operator of another vehicle moving behind the automobile. In turn, knowning the front car is reduced to 60 miles per hour, the driver behind may slow down his/her vehicle in response to the moving status, such as the reduced speed of 60 miles per hour, of the vehicle in front shown by the displaying device 106 by reducing his/her own speed to below 60 miles per hour to keep the safety distance. Additionally, the driver in the front vehicle may bring his/her speed down further by stepping on the foot brake numerous times. As such, the displaying device 106 may display the speed each time the driver activates the decelerating device 102, allowing the driver behind to know the moving status of the front vehicle. For example, the displaying device 106 may display 50, as shown in FIG. 3b, to show the front vehicle has brought its speed down to 50 miles per hour, and so on so for. In turn, the driver behind may react accordingly.

In another example, the automobile may be moving at a constant speed at 40 miles per hours before the accelerating device 108 is activated. At the time the accelerating device 108 is activated, such as when the operator of the automobile steps on the gas pedal, the speed of the automobile may be increased to 50 miles per hour. As such, the displaying device 106 may display such speed to the driver of another vehicle moving behind the automobile. In one embodiment of the present invention, the displaying device 106 may display the speed numerically. In another embodiment of the present invention, the displaying device 106 may display the speed graphically.

Refer now to FIG. 3a, which is a schematic view illustrating a system for conveying a moving status of a motorized vehicle in accordance with one embodiment of the present invention. As shown in FIG. 3a, the displaying device 306 of the present invention (same as the displaying device 106 in FIG. 1) may be disposed on a brake indicator 310 located in a rear end of the motorized vehicle so that an operator of a vehicle moving behind it may adjust the distance between the two vehicles to prevent collision. In one embodiment, the brake indicator 310 shown in FIG. 3a is located on a top end of a rear windshield of the motorized vehicle. However, the brake indicator of the present invention may also be located at a bottom end of the rear windshield of the motorized vehicle, as shown in FIG. 3b. Alternatively, the brake indicator 310 may be located on a spoiler (not shown). The brake indicator, such as brake indicators 320 and 330, may also be located at a rear end of the motorized vehicle, as shown in FIGS. 3a and 3b. As such, the displaying device 306 may alternatively be disposed on the brake indicators 320 and/or 330. Alternatively, the displaying device 306 may be disposed in any place other than the brake light, such as brake light 310, 320 or 330, as long as the moving status, such as speed, may be seen by the driver behind the front vehicle.

In one embodiment of the present invention, the displaying device 106 may be consisted of a plurality of LED lights. In one embodiment of the present invention, the LED lights may be used to display the moving status. For example, whereas the brake indicator 310 normally signals in red color to warn others that a brake is pressed, the LED lights of the displaying device 106 may show the instantaneous speed measured by the measuring device 104 in white. In one embodiment of the present invention, the LED lights of the displaying device 106 may display the instantaneous speed numerically, for example, in white light. In another embodiment of the present invention, the LED lights of the displaying device 106 may display the instantaneous speed graphically. For example, the LED lights may show the instantaneous speed graphically in white so that the speed shown by the displaying device 106 may be distinguished from the red warning signal shown by the brake indicator, such as brake indicator 310, 320 or 330. However, the displaying device 106 of the present invention is not limited to LED lights. Any other displaying device, known in the art or developed in the future that is capable of displaying the instantenous speed numerically or graphically also falls under the scope of the present invention.

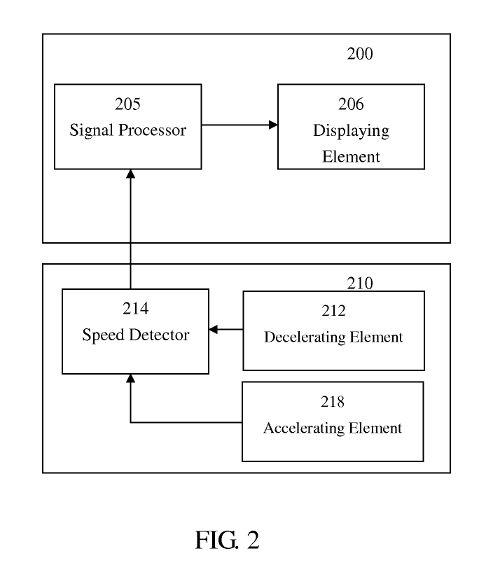

Refer now to FIG. 2, which illustrates a block diagram of a device for conveying a moving status of a motorized vehicle in accordance with one embodiment of the present invention. As shown in FIG. 2, the device for conveying a moving status of a motorized vehicle 200 may be adapted to work with the motorized vehicle 210. The device of the present invention 200 may include a signal processor 205 and a displaying element 206.

As shown in FIG. 2, in one embodiment of the present invention, the signal processor 205 may be electrically coupled to a speed detector 214 installed within the motorized vehicle 210. In accordance with the present invention, the speed detector 214 may detect an instantaneous speed of the motorized vehicle 210. As an example, the speed detector 214 may detect the speed signal at the time a decelerating element 212 of the motorized vehicle is activated. In turn, the signal processor 205 may convert such speed signal detected by the speed detector 214 into a numeric display. In another example, the speed detector 214 may detect the speed signal at the time an accelerating element 218 of the motorized vehicle is activated. In turn, the signal processor 205 may also convert such speed signal detected by the speed detector 214 into a numeric display.

Subsequently, the displaying element 206 of the present invention may display the numeric display to an object behind the motorized vehicle. As explained above, the displaying element 206 may be disposed on a brake indicator, such as the brake indicator 310, 320 or 330 shown in FIG. 3a and FIG. 3b, located in the rear end of the motorized vehicle 210 to allow the operator of the vehicle moving behind it to adjust the distance between the two vehicles accordingly so as to prevent collision. Also as explained above, the brake indicator may be located on a rear windshield of the motorized vehicle, such as brake indicator 310 shown in FIGS. 3a and 3b. Alternatively, the brake indicator 310 may be located on a spoiler (not shown). Or, the displaying device 306 may be disposed in any place other than the brake light, such as brake light 310, 320 or 330, as long as the moving status, such as speed, may be been by the driver behind the front vehicle.

Additionally, the displaying element 206 of the present invention may be consisted of a plurality of LED lights. In one embodiment of the present invention, the LED lights may be used to display the moving status. For example, whereas the brake indicator 310 normally signals in red color to warn others that a brake is pressed, the LED lights of the displaying element 206 may show the instantaneous speed detected by the speed detector 214 in white. In one embodiment of the present invention, the LED lights of the displaying element 214 may display the instantaneous speed numerically, for example, in white light. In another embodiment of the present invention, the LED lights of the displaying element 214 may display the instantaneous speed graphically. For example, the LED lights may show the instantaneous speed graphically in white so that the speed shown by the displaying device 106 may be distinguished from the red warning signal shown by the brake indicator, such as brake indicator 310, 320 or 330.

While the invention has been described in conjunction with exemplary preferred embodiments, it is to be understood that many alternatives, modifications, and variations will be apparent to those skilled in the art in light of the foregoing description. Accordingly, the present invention embraces all such alternatives, modifications, and variations. All matters set forth herein or shown in the accompanying drawings are to be interpreted in an illustrative and non-limiting sense.

1. A system for conveying a moving status of a motorized vehicle, said system comprising:
a decelerating device operable to slow down said motorized vehicle;
a measuring device electrically coupled to said decelerating device to measure an instantaneous speed of said motorized vehicle at a time said decelerating device is activated; and
a displaying device electrically coupled to said measuring device to display said instantaneous speed to an object behind said motorized vehicle.

2. The system of claim 1, wherein said displaying device is disposed on a brake indicator located in a rear end of said motorized vehicle so as to allow said object behind said motorized vehicle to adjust a distance between said motorized vehicle and said object accordingly.

3. The system of claim 2, wherein said brake indicator is located on a windshield of said motorized vehicle.

4. The system of claim 2, wherein said displaying device is capable of displaying said instantaneous speed numerically.

5. The system of claim 2, wherein said displaying device is capable of displaying said instantaneous speed graphically.

6. The system of claim 4, wherein said displaying device consists of a plurality of LED lights capable of displaying said instantaneous speed, said instantaneous speed is shown in a color other than that shown by said brake indicator.

7. The system of claim 1, further comprising an accelerating device electrically coupled to said measuring device to allow said measuring device to measure an instantaneous speed of said motorized vehicle at a time said accelerating device is activated and to allow said displaying device to display said instantaneous speed to said object behind said motorized vehicle.

8. A device for conveying a moving status of a motorized vehicle, said device adapted to work with said motorized vehicle, said device comprising:
a signal processor electrically coupled to a speed detector of said motorized vehicle to convert a speed signal detected by said speed detector into a numeric display; and
a displaying element disposed at a rear end of said motorized vehicle to display said numeric display to an object behind said motorized vehicle.

9. The device of claim 8, wherein said displaying element is disposed on a brake indicator located in said rear end of said motorized vehicle so as to allow said object behind said motorized vehicle to adjust a distance between said motorized vehicle and said object accordingly.

10. The device of claim 9, wherein said brake indicator is located on a windshield of said motorized vehicle.

11. The device of claim 9, wherein said displaying element consists of a plurality of LED lights capable of displaying said numeric display, said numeric display is shown in a color other than that shown by said brake indicator.

12. The device of claim 8, wherein said speed signal detected by said speed detector is a speed at a time a decelerating element of said motorized vehicle is activated.

13. A system for showing a moving status of a motorized vehicle, said system comprising:
a measuring device measuring an instantaneous speed of said motorized vehicle; and
a displaying device electrically coupled to said measuring device, wherein said displaying device is disposed in a rear end of said motorized vehicle so as to display said instantaneous speed measured by the measuring device to an object behind said motorized vehicle.

14. The system of claim 13, wherein said displaying device is disposed on a brake indicator in said rear end of said motorized vehicle.

15. The system of claim 13, further comprising a decelerating device to reduce said instantaneous speed of said motorized vehicle when activated, wherein said displaying device displays said instantaneous speed measured by the measuring device at a time said decelerating device is activated to said object behind said motorized vehicle.

16. The system of claim 13, further comprising an accelerating device to accelerate said instantaneous speed of said motorized vehicle when activated, wherein said displaying device displays said instantaneous speed measured by the measuring device at a time said accelerating device is activated to said object behind said motorized vehicle.

17. The system of claim 14, wherein said displaying device consists of a plurality of LED lights capable of displaying said instantaneous speed, said instantaneous speed is shown in a color other than that shown by said brake indicator.

18. The system of claim 14, wherein said displaying device is capable of displaying said instantaneous speed numerically.

19. The system of claim 14, wherein said brake indicator is located on a windshield of said motorized vehicle.

20. The system of claim 5, wherein said displaying device consists of a plurality of LED lights capable of displaying said instantaneous speed, said instantaneous speed is shown in a color other than that shown by said brake indicator.
